(19) United States
(12) Patent Application Publication
(10) Pub. No.: US 2003/0213440 A1
(43) Pub. Date: Nov. 20, 2003

(54) Cat toy

(76) Inventor: Jennifer A. Kelly, Mosinee, WI (US)

Correspondence Address: SANJAY AGRAWAL, LAW OFFICE OF SANJAY AGRAWAL, 11 MORWOOD LANE, ST. LOUIS, MO, 63141, US

(21) Appl. No.: 10/146,535

(22) Filed: May 15, 2002

(51) Int. Cl. A01K 29/00

(52) U.S. Cl. 119/708

(57) ABSTRACT

A breathable material is folded and sewn together to form a snake shaped object having a cavity with a first end and a second end. The object may be shaped like an animal, such as a snake, an insect, a rodent, or reptile. The object includes jingle bells located within the cavity towards the first end of the object. At the second end of the object, a plurality of tassels extend longitudinally. Within the object, between the jingle bells and the tassels are a pair of sachets containing catnip. The breathable material is light weight and permits the cat to suck the catnip through the breathable material. The toy makes a ringing sound when batted, bitten or shaken by the cat.

Further, the toy distracts the cat from damaging household goods made of wool and provides an environmentally safe toy to entertain the cat.

### BACKGROUND OF THE INVENTION

This invention relates generally to the amusement of a cat and, more particularly, to a snake shaped toy including bells, tassels, and catnip.

Cats have been around since the time of the Egyptian pharaohs, and various methods have been employed by their owners to entertain them over the centuries. Cats are driven by instinctual hunting habits which cause them to chase objects. It is well known that a ball of yarn or a ping-pong ball will entertain a cat for hours. Thus, the use of a play toy for a cat is known in the prior art. This cat toy unlike most in the prior art is inert and should be moved around manually. Cats have a keen sense of smell and can be lured by the use of scents. In particular, cats are fond of the odor of catnip, which is a plant of the mint family with strongly scented leaves. This invention includes bells, tassels, and catnip to attract and tease the cat.

### BRIEF SUMMARY OF THE INVENTION

In an exemplary embodiment, a breathable material is folded and sewn together to form an object in the shape of a snake having a cavity with a first end and a second end. The snake shaped object has a cavity extending from the first end to the second end. The object includes jingle bells located within the cavity towards the first end of the object. At the second end of the object, a plurality of tassels extend longitudinally. Within the object, between the jingle bells and the tassels are a pair of sachets containing catnip. The breathable material is light weight and permits the cat to suck the catnip through the breathable material. The toy makes a ringing sound when batted, bitten or shaken by the cat.

One object of the invention is to provide a cat toy that maybe easily and efficiently manufactured and marketed. Another object of the invention is to provide a cat toy which is made of a durable and reliable construction. Yet, another object of the invention is to make a cat toy that is environmentally safe and safe for the cat to play with. Still another object of the invention is to distract the cat from damaging household goods made of wool. A cat toy invention is therefore provided to attract and entertain the cat.

### BRIEF DESCRIPTION OF THE DRAWINGS

FIG. 1 is a schematic view of a cat toy assembly;

FIG. 2 is a schematic view of the cat toy assembly shown in FIG. 1 in a position for replacing sachets filled with catnip;

FIG. 3 is a perspective view of the cat toy shown in FIG. 1 attached to a rod and cord assembly in an embodiment of the invention;

FIG. 4 is a perspective view of one embodiment of the rod inserted into the handle of the rod and cord assembly shown in FIG. 3;

FIG. 5 is another embodiment of the rod inserted into an ergonomically fitting handle of the rod and cord assembly shown in FIG. 3; and

FIG. 6 is a perspective view of a cord attached to a connection point on the rod shown in FIG. 3.

### DETAILED DESCRIPTION OF THE INVENTION

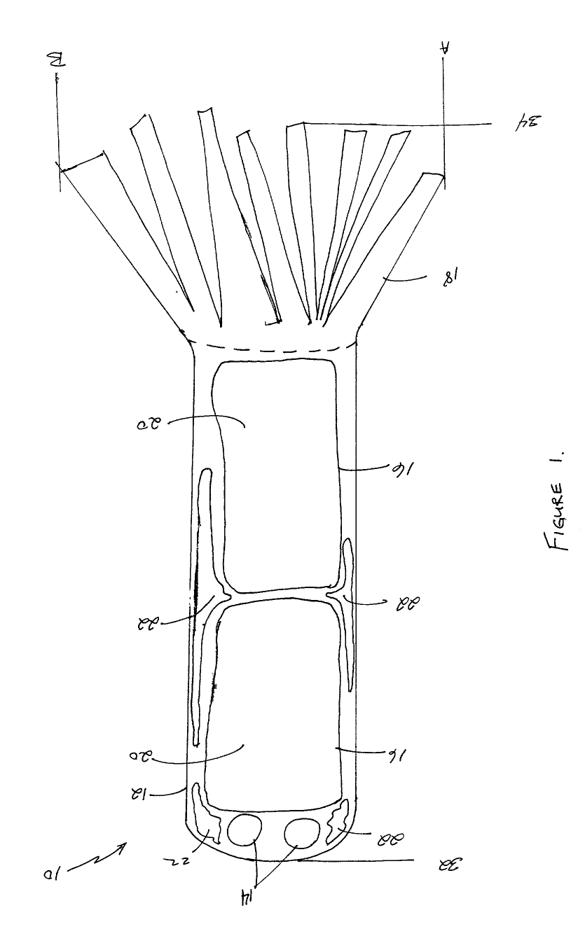

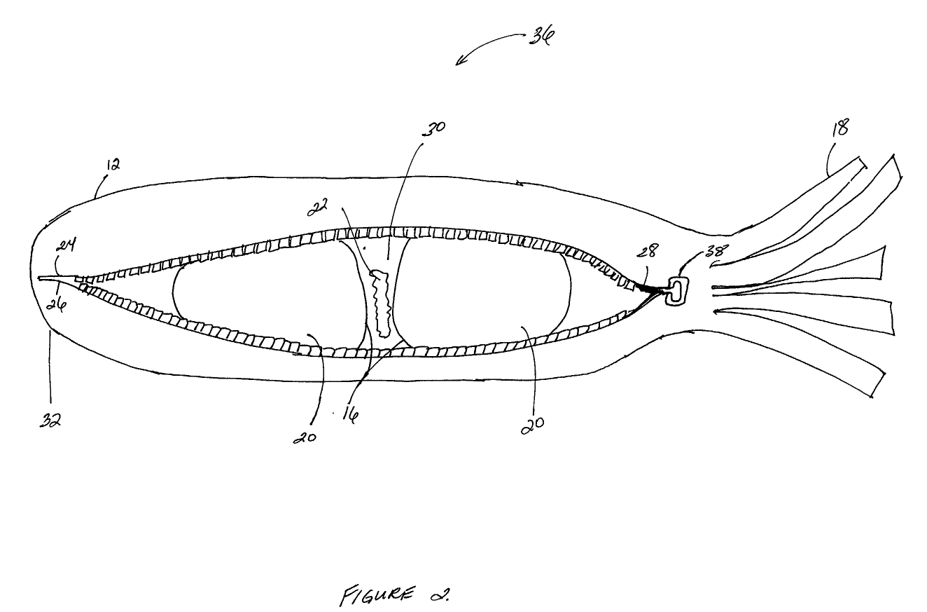

FIG. 1 is a schematic view of a cat toy assembly 10. Cat toy assembly 10 includes an exterior breathable material 12, a plurality of jingle bells 14, a plurality of removable sachets 16, a plurality of tassels 18, a plurality of catnip 20, and polyfill stuffing 22. Breathable material 12 is a single piece of material that allows the aroma of catnip 20 enclosed in sachets 16 to permeate to the exterior of cat toy assembly 10. In one embodiment, breathable material 12 has a first edge 24 (shown in FIG. 2) and a second edge 26 (shown in FIG. 2) that are sealed together to form a sealed edge 28. Sealed edge 28 runs along the body of cat toy 10 (which is not shown) and along the width of cat toy 10 as shown in FIG. 1. Breathable material 12 is folded to form a cylindrical shape having a cavity 30 (shown in FIG. 2). Within cavity 30, jingle bells 14 are located toward a first end 32 and tassels 18 are located toward a second end 34. Inside cavity 30, the plurality of sachets 16 containing catnip 20 are located between the jingle bells 14 and the tassels 18. The surrounding space between each sachet 16 is filled with polyfill stuffing 22.

In an exemplary embodiment, breathable material 12 is wool fleece. Wool fleece permits the aroma of catnip 20 to exude and attract the cat. In an alternative embodiment, breathable material 12 is fabricated from a knit material. In a further alternative embodiment, breathable material 12 is fabricated from cotton. In a still further embodiment breathable material 12 is fabricated from acrylic. In another embodiment, breathable material 12 is fabricated from silk. In yet another embodiment, breathable material 12 is made of a fur-like material to simulate a rodent. In addition, breathable material 12 can be dyed a variety of different solid colors, a variety of patterned colors, and a mixture of colors all which are chosen to attract the cat. In an exemplary embodiment, breathable material 12 maybe dyed an assortment of colors for a tie-dyed appearance. In another embodiment, breathable material 12 is dyed camouflage colors.

Breathable material 12 is fabricated from a single piece of material, which is very economical because a number of pieces do not have to be matched and fitted together. Thus, no additional labor is required to match pieces and fit them together in the process of toy manufacturing.

The shape of cat toy 10 is discretionary and can take on the shape, for example, of a small animal, insect, rodent, or reptile. The chosen shape of cat toy 10 is one that will attract the cat. In an exemplary embodiment, breathable material 12 is shaped into a cylinder so cat toy 10 resembles a snake. Preferably, the depth and width of cat toy 10 are selected to allow the cat to grasp cat toy 10 with its mouth. In an exemplary embodiment, cat toy 10 has a width of at least two-and-a-half inches, has a body length of at least nine inches, has a depth of at least a quarter inch, and has tassels 18 having a length of at least five inches with tassels 18 spanning at least six inches from A to B as shown in FIG. 1. Tassels 18 act as a tail so as to increase the resemblance of cat toy 10 to a rodent to attract the cat. In addition, cat toy 10 is lightweight and should be easily carried by the cat.

Breathable material 12 can be sealed by a variety of methods. In one embodiment, sealing is performed by sewing. In another embodiment, a zipper 38 (shown in FIG. 2) is used to seal breathable material 12. In one embodiment zipper 38 is fabricated from nylon. In another embodiment, zipper 42 is fabricated from plastic. The material chosen for zipper 38 is selected so the cat will not be injured when the cat uses its claws to scratch zipper 38 or the cat uses its teeth to bite zipper 38. Further, sealing is performed with safety of the cat in mind. In yet another embodiment, velcro is utilized to seal breathable material 12. Breathable material 12 is sealed to prevent the cat from gaining access to cavity 30 and the contents therein. Sealing is performed to create a single seam along an edge 28 that runs the length of cat toy 10 from first end 32 to second end 34 and then across the width of cat toy 10. Edge 28 is a tight seal that will not tear open and spill the contents of cavity 30 when the cat either scratches, pulls, bites or mangles edge 28 with its' claws or its' teeth.

In an exemplary embodiment, a pair of sachets 16 are utilized when fabricating cat toy 10 having a snake shape. Sachets 16 are filled with catnip 20. Sachets 16 can be of varying shape and size to accommodate the desired shape and size of cat toy 10 being designed. For instance, depending on the shape of cat toy 10, a plurality of sachets 16 can be utilized. In an exemplary embodiment, to provide a snake like shape, sachets 16 have a length of less than four inches, a width less than two-and-a-quarter inches, and a height of less than two inches.

In one embodiment, sachets 16 are fabricated from nylon. In another embodiment, sachets 16 are fabricated from muslin. In still another embodiment, sachets 16 are fabricated from nylon netting. In yet another embodiment, sachets 16 are fabricated from cheese cloth.

When sachets 16 are not used, breathable material 12 is filled with catnip 20. However, by not using sachets 16, catnip 20 would be used as a stuffing that is not readily malleable to form a desired shape of cat toy 10; for instance an elongated cylinder shaped like a snake. Without sachets 16, the stems of catnip 20 have a tendency to protrude through breathable material 12 such that a substantially smooth outer surface cannot be fabricated. In addition, any protruding stems can injure the cat. Therefore, sachets 16 filled with catnip prevent harm to the cat by preventing the stems of catnip from protruding through breathable material 12. Further, sachets 16 allow catnip 20 to be easily replaced without creating a mess.

In between each sachet 16 and within cavity 30, polyfill stuffing 22 is used to hold sachets 16 in place and provide form for the desired shape of cat toy 10. Polyfill stuffing 22 is a high insulation, light-weight fiber used as a filling for coats, sleeping bags, blankets, mattresses, and upholstery. Polyfill stuffing 22 is commercially available and is fabricated from nylon, polyester, and cotton. In an exemplary embodiment, polyfill stuffing 22 is manufactured by Carpenter Company, Taylor, Tex. 76574. In another embodiment, polyfill stuffing 22 is manufactured by El Dupont de Nemours & Company, Wilmington, Del. 19880-0010.

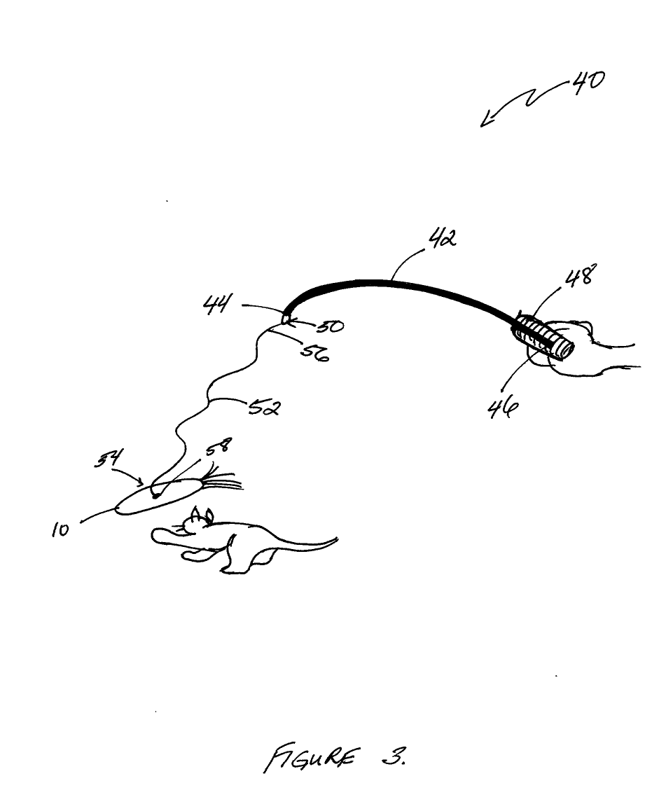

A variety of means are utilized to attract the cat to play with cat toy 10. In an exemplary embodiment, breathable material 12 is dyed an assortment of colors for a tie-dyed appearance. In addition, jingle bells 14 rattle and attract the cat when cat toy 10 is shaken or moved. Furthermore, tassels 18 simulate the tail of a rodent and attract the cat's attention when cat toy 10 is shaken or moved. As cats are known to have an affinity for the smell of catnip 20, the catnip 20 is filled in sachets 16 and breathable material 12 allows the aroma of catnip 20 to exude through the material to attract the cat. The cat is attracted to the catnip and will try to suck the catnip through breathable material 12. In an exemplary embodiment, breathable material 12 is wool fleece. It is known that cats will chew on sweaters, suck on towels, blankets or even carpets. This behavior has been termed as “wool sucking.” This behavior of cats may damage the material that the cat is sucking on. Any type of fabric is susceptible, although cats seem to be partial to wool. In an exemplary embodiment, catnip 20 is organically grown and free of pesticides. In another embodiment, described below, cat toy 10 is attached to a rod and cord assembly 40 (shown in FIG. 3) that dangles cat toy 10 in front of the cat permitting a user to tease the cat. This invention entertains the cat and distracts the cat from damaging other household items fabricated from wool.

FIG. 2 is a schematic view of the cat toy assembly 10 shown in FIG. 1 in a position for replacing 36 sachets 16 filled with catnip 20. Elements identified in FIG. 2 use the same reference number as identical elements identified in FIG. 1. In one embodiment, breathable material 12 forms cavity 30 that can be opened and closed. Cavity 30 contains jingle bells 14 (shown in FIG. 1) and sachets 16 filled with catnip 20. Catnip 20, is a herb that becomes stale over time and needs to be replaced in order to maintain a fresh aroma. In one embodiment of the invention, a zipper 38 is used to open and close a cavity 30 to simplify replacing sachets 16 filled with catnip 20. In another embodiment, velcro (not shown) can be used to open and close cavity 30 to replace sachets 16.

FIG. 3 is a perspective view of cat toy 10 attached to a rod and cord assembly 40 in one embodiment of the invention. Rod and cord assembly 40 includes a rod 42 having a first end 44 and a second end 46, a connection point 50 located at first end 44, a handle 48, and a cord 52 having a first end 54 and a second end 56. Rod 42 is attached to handle 48 at second end 46. A cord 52 having a first end 54 and a second end 56 is attached to rod 42. Cord 52 first end 54 is attached to rod 42 at first end 44, and cord 52 second end 56 is attached to cat toy 10 at an attachment point 58 located on cat toy 10. Attachment point 58 can be located anywhere on cat toy 10. In the embodiment shown in FIG. 3, attachment point 58 is located in the middle of cat toy 10.

Rod 52 is attached to handle 48 by various known means. Preferably, rod 52 is fabricated from any flexible material. In one embodiment rod 52 is fabricated from plastic. In another embodiment rod 52 is fabricated from wood. In still another embodiment rod 52 is fabricated from fiberglass. In yet another embodiment, rod 52 is fabricated from bamboo. Rod 52 preferably should be resilient and capable of being bent or deflected without breaking and, after being deformed, return generally to its original shape.

Handle 48 is fabricated from a variety of materials and can take on a variety of shapes and sizes. In one embodiment, handle 48 is fabricated from wood. In another embodiment handle 48 is fabricated from rubber. In still another embodiment, handle 48 is fabricated from plastic. In a further embodiment handle 48 is fabricated from fiberglass. In a still further embodiment, handle 48 is fabricated from polyvinyl chloride (commonly known as “PVC”). In yet another embodiment, handle 48 is fabricated from polyethylene. In addition, handle 48 can take on many shapes. For instance, the shape of handle 48 can be cylindrical, rectangular, octagonal, hexagonal, or contain a plurality of facet edges where the edges can be rounded or sharp to provide an ergonomic shape for a user to grip handle 48.

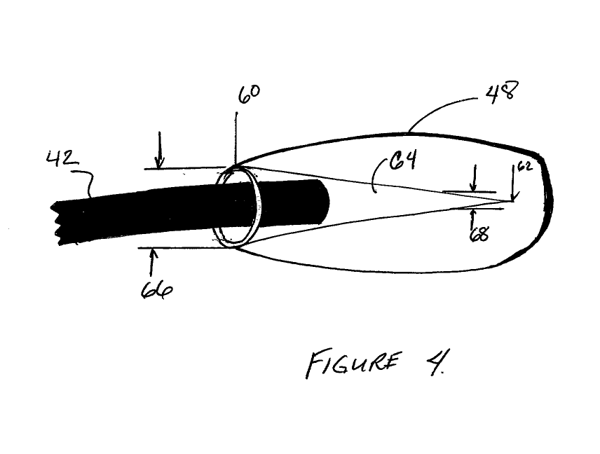

Rod 42 is attached to handle 48 in a variety of known means. FIG. 4 is a perspective view of one embodiment of rod 42 inserted into handle 48. In this embodiment, handle 48 is fabricated from wood and has a first end 60 and a second end 62 and includes a V-shaped groove 64 drilled in the radial center of handle 48. V-shaped groove 64 has a first diameter 66 and a second diameter 68, where first diameter 66 is larger than second diameter 68. In one embodiment second diameter 68 is a tapered end 69. Tapered end 69 is located near second end 62. Within V-shaped groove 64, rod 42 is inserted until rod 42 is tight and snug within handle 48.

In another embodiment (not shown), handle 48 is fabricated from wood. Handle 48 is cylindrically shaped, has a substantially smooth outer surface, and a hole bored along its longitudinal axis. The diameter of the bored hole is less than the diameter of the diameter of handle 48. Rod 42 is coated with a glue and inserted into the bored hole.

In yet another embodiment (not shown), handle 48 contains within the bored hole a plurality of screw turns. Rod 42 has a matching set of screw turns (not shown) such that rod 42 is configured to screw into handle 48 when inserted into handle 48. A number of methods of inserting rod 42 into handle 48 are available in the art. These embodiments are not meant to limit the method or means by which rod 42 is inserted and retained within handle 48.

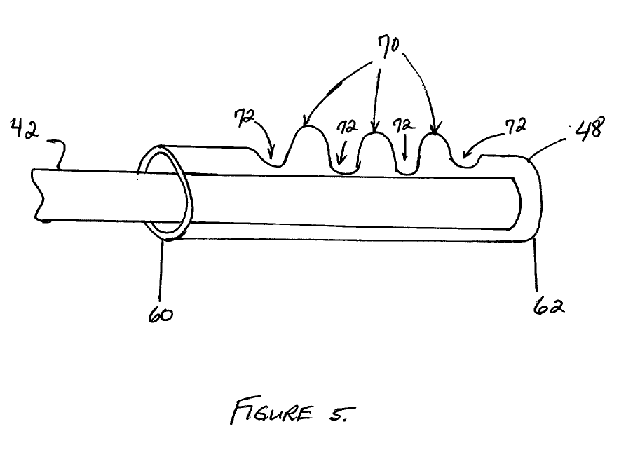

FIG. 5 is another embodiment of rod 42 configured to be inserted into handle 48. In this embodiment, handle 48 has a plurality of ridges 70, a plurality of valleys 72. Further, handle 48 forms a hollow cylinder having an open first end 60 and a closed second end 62. In such an embodiment, rod 42 is configured to slide inside open first end 60 and continues to be inserted into handle 48 until rod 42 reaches closed second end 62. In one embodiment, handle 48 is fabricated from rubber. In another embodiment handle 48 is fabricated from plastic. In a further embodiment, handle 48 is fabricated from polyethylene. The material used to fabricate handle 48 should be capable of being molded with ridges 70 and valleys 72 on the exterior surface of handle 48 to ergonomically fit human fingers.

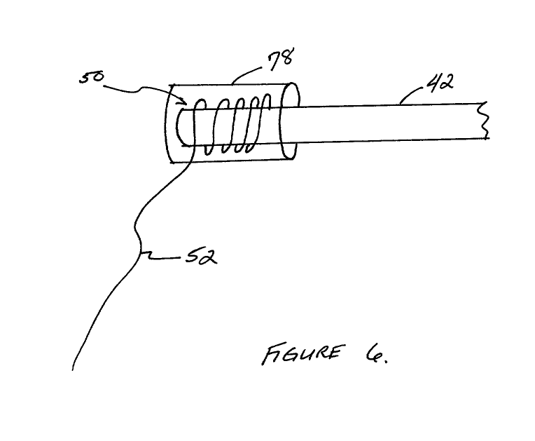

Cord 52 is attached to rod 42 at connection point 50 by a variety of means. In an embodiment shown in FIG. 6, cord 52 is tightly wrapped around rod 42. A plastic sleeve 78 is wrapped around cord 52 and is heated until the plastic melts and binds cord 52 to rod 42. In another embodiment, a loop is attached to rod 42, and cord 52 is tied to the loop (not shown). A number of methods of attaching cord 53 to rod 42 are available in the art. These embodiments are not meant to limit the method or means by which cord 52 is attached to rod 42.

Cord 52 is fabricated from any elastic material that has resilience and returns to its original shape after being deformed, bent or twisted. In one embodiment cord 52 is fabricated from an elastic material. In another embodiment, cord 52 is fabricated from a nylon line. In yet another embodiment, cord 52 is fabricated from fabricated from a nylon line. In yet another embodiment, cord 52 is fabricated from yarn. In a further embodiment, cord 52 is fabricated from string. There are many means of attaching cord 52 to rod 42 known in the art. The above examples are not meant to limit the method by which cord 52 is attached to rod 42 and only serve as various embodiments.

Cord 52 is attached to cat toy 10 at attachment point 58, which can be located anywhere on cat toy 10. In one embodiment, attachment point 58 is a plastic button. In an alternative embodiment, attachment point 58 is fabricated from Velcro@. In still a further embodiment, attachment point 58 is a loop of plastic that has a first end, a second end, both which are anchored below the surface of cat toy 10.

Being hunters, cats are attracted to the movement of objects. Rod and cord assembly 40 allows a user to tease the animal with cat toy 10. Therefore, the location where cord 52 is attached to cat toy 10 is not significant, for the purpose of rod and cord assembly 40 is to use cat toy 10 to tease the cat.

While the invention has been described in terms of various specific embodiments, those skilled in the art will recognize that the invention can be practiced with modification within the spirit and scope of the claims.

What is claimed is:

1. A cat toy comprising:
an enclosure having a first end and a second end and an inner chamber;
a jingle bell located within said inner chamber;
a pair of sachets located within said inner chamber between said first end and said second end;
a plurality of polyfill stuffing located between said jingle bell and said pair of sachets; and
a plurality of tassels extending from either said first end or said second end.

2. A cat toy in accordance with claim 1 wherein said enclosure comprises a breathable material permitting the aroma of catnip to exude.

3. A cat toy in accordance with claim 1 wherein said enclosure comprises at least one of a wool fleece material, a wool material, an acrylic material, a knit material, a silk material, and a cotton material.

4. A cat toy in accordance with claim 1 wherein said sachets comprises a breathable material permitting the aroma of catnip to exude.

5. A cat toy in accordance with claim 1 wherein said sachets contain catnip.

6. A cat toy in accordance with claim 1 wherein said sachets are removable and replaceable.

7. A cat toy in accordance with claim 1 wherein said sachets comprise at least one of a nylon material, a muslin material, a nylon netting material, and a cheese cloth material.

8. A method of making a cat toy which comprises the steps of:
providing a breathable material having a first edge and a second edge;
folding said breathable material to form a cavity having a first end and a second end, and an outer surface;
inserting at least one jingle bell into said cavity;
inserting at least one sachet into said cavity;
inserting polyfill stuffing into said cavity;
sealing said cavity to form a sealed edge; and
cutting said breathable material to form a plurality of tassels.

9. A method in accordance with claim 8 wherein said breathable material comprises at least one of a wool fleece material, a wool material, an acrylic material, a knit material, a silk material, and a cotton material.

10. A method in accordance with claim 8 wherein said step of inserting a pair of sachets further comprises the step of inserting fresh, organic catnip into said pair of sachets.

11. A method in accordance with claim 8 wherein said sachets comprise at least one of a nylon material, a muslin material, a nylon netting material, and a cheese cloth material.

12. A method in accordance with claim 8 wherein said step of inserting said polyfill stuffing further comprises the step of inserting polyfill stuffing into said cavity to provide a substantially smooth outer surface.

13. A method in accordance with claim 8 wherein said step of sealing further comprises at least one of sewing said first edge and said second edge, Velcroing® said first edge and said second edge, and zippering said first edge and said second edge.

14. A cat toy comprising:
a rod having a first end and a second end, a handle, a connection point, a cord having a fixed end and a free end, an attachment point, and an object to amuse the cat, said handle attached to said rod first end;
said connection point located at said rod second end;
said cord fixed end attached to said connection point;
said cord free end attached to said attachment point; and
said attachment point located on said object to amuse the cat.

15. A cat toy in accordance with claim 14 wherein said rod is a resilient rod that can be deformed.

16. A cat toy in accordance with claim 15 where said resilient rod comprises at least one of a plastic material, a bamboo material, and a fiberglass material.

17. A cat toy in accordance with claim 15 wherein said resilient rod has a diameter less than the diameter of said handle, such that said rod is configured to be inserted into said handle.

18. A cat toy in accordance with claim 14 wherein said handle is fabricated of at least one of a wooden material, a plastic material, a fiberglass material, a polyvinyl-chloride material, a polyethylene material and a rubber material.

19. A cat toy in accordance with claim 14 wherein said cord is of at least one of an elastic material, a nylon material, a yarn material, and a string material.

20. A cat toy in accordance with claim 14 wherein said attachment point is at least one of a loop, a plastic button, and Velcro®.
